(19) United States
(12) Patent Application Publication
(10) Pub. No.: US 2015/0063562 A1
(43) Pub. Date: Mar. 5, 2015

(54) ELECTRONIC AUTOGRAPH MANAGEMENT FOR IMAGES AND PHOTOGRAPHS

(71) Applicants: Lana M. Nilsen, Sarasota, FL (US); Anders M. Nilsen, Sarasota, FL (US)

(72) Inventors: Lana M. Nilsen, Sarasota, FL (US); Anders M. Nilsen, Sarasota, FL (US)

(21) Appl. No.: 14/471,229

(22) Filed: Aug. 28, 2014

Related U.S. Application Data
(60) Provisional application No. 61/870,967, filed on Aug. 28, 2013.

(51) Int. Cl. H04L 9/32; H04L 9/08

(52) U.S. Cl. CPC H04L 9/3247; H04L 9/08; H04L 2209/24; H04L 2209/72
USPC 380/28

(57) ABSTRACT

Systems and methods can support electronic autograph management for images and photographs. A mobile electronic device can receive one or more cryptographic keys and/or digital certificates. A digital image may be acquired using a camera or other image sensor associated with the mobile electronic device. An autograph may be received in association with the digital image. The digital image and the autograph may be securely coupled using one of the cryptographic keys. The cryptographically coupled digital image and autograph may be stored locally and/or transited to an online archive. A secure online marketplace can allow the autographed image to be shared, traded, bought, sold, or otherwise transacted.

### RELATED APPLICATION

This application claims priority to U.S. Provisional Patent Application No. 61/870,967, filed Aug. 28, 2013 and entitled “PICSIG and SIGFIG.” The complete disclosure of the above-identified priority application is hereby fully incorporated herein by reference.

### BACKGROUND

Photographs taken of individuals cannot generally be autographed by those individuals at the time of the photograph being taken. Traditionally, the photograph must be developed or printed to paper or some other physical medium prior to being autographed by the subject of the photograph. Such operations are not generally accomplished, particularly with any reasonable level of quality, in the field as photograph opportunities arise. Furthermore, authenticating, storing, sharing, trading, or selling of autographed photographs are all traditionally nontrivial tasks require cumbersome handling of physical printed or developed photographs that may then be lost or damaged and generally degrade over time.

There is a need in the art for an electronic autograph management system operable to capture an image of an individual and then support that individual applying their autograph to the captured image almost immediately thereafter while the photographer is still in the presence of the individual being photographed.

### SUMMARY

In certain example embodiments described herein, methods and systems can support electronic autograph management for images and photographs. A mobile electronic device can receive one or more cryptographic keys and/or digital certificates. A digital image may be acquired using a camera or other image sensor associated with the mobile electronic device. An autograph may be received in association with the digital image. The digital image and the autograph may be securely coupled using one of the cryptographic keys. The cryptographically coupled digital image and autograph may be stored locally and/or transited to an online archive. A secure online marketplace can allow the autographed image to be shared, traded, bought, sold, or otherwise transacted.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an electronic autograph management system in accordance with one or more embodiments presented herein.

FIG. 2 is an example screen image associated with a user mobile device in accordance with one or more embodiments presented herein.

FIG. 3 is a block flow diagram depicting a method for electronic autograph management in accordance with one or more embodiments presented herein.

FIG. 4 is a block diagram depicting a computing machine and a module in accordance with one or more embodiments presented herein.

### DETAILED DESCRIPTION OF EXAMPLE EMBODIMENTS

### Overview

The methods and systems described herein enable electronic autograph management for images and photographs. An operator of an electronic device such as a digital camera, smart phone, tablet, portable computer, or so forth may use a camera associated with the electronic device to capture an image of another individual. The other individual, who may be a celebrity, public figure, relative or friend, may then serve as an inscriber to apply their autograph to the captured image.

The operator can select an icon or menu option on their device screen or interface to activate an autograph box. The signing individual (also referred to as the inscriber) can enter their autograph into the autograph box. The autographed picture may then be securely saved with a date and time stamp for improved authenticity. Securely saving the image and autograph may include cryptographic signing and/or hashing. Acquired images along with their applied signatures, timestamps, and other metadata may be collected, traded, bought, sold, auctioned, gifted, shared, or otherwise transacted via a secured online marketplace.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

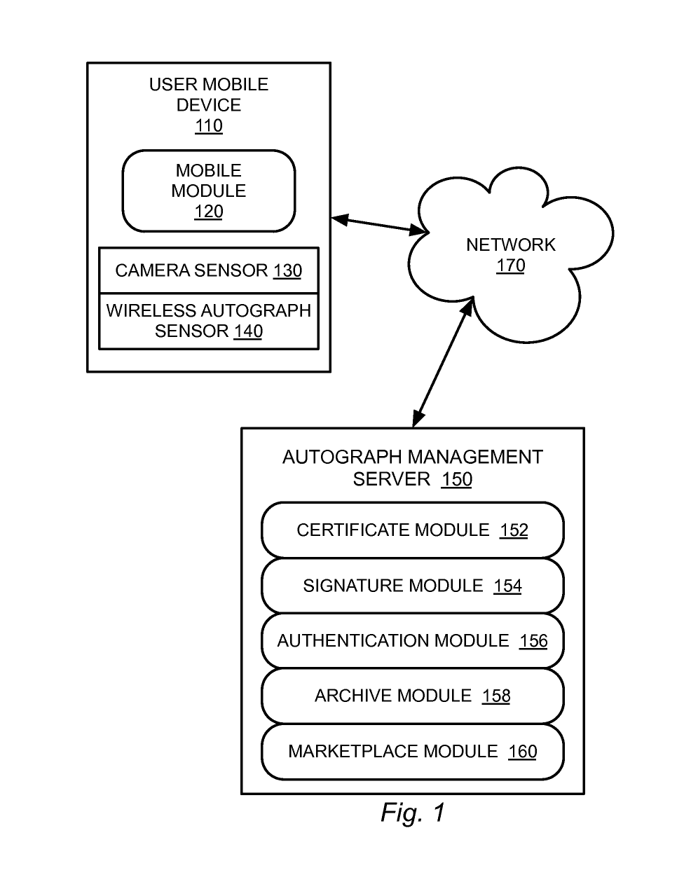

FIG. 1 is a block diagram depicting an electronic autograph management system in accordance with one or more embodiments presented herein. An operator of a user mobile device 110 may acquire an image or photograph using a camera sensor 130 associated with the user mobile device 110. An inscriber may autograph or sign the image or photograph using an input mechanism of the user mobile device 110, such as a touch screen. According to certain embodiments, the inscriber may be the subject of the image or photograph such as a celebrity or public figure that has been photographed and then agrees to autograph their image according to the technology presented herein. According to certain embodiments, the inscriber may apply their signature or autograph by writing their signature on an input device associated with the user mobile device 110, such as a touch screen. According to further embodiments, the inscriber may apply their signature or autograph by signaling to a wireless autograph sensor 140 associated with the user mobile device 110. The wireless autograph sensor 140 may be signaled using a wireless token. Functionality associated with the user mobile device 110, including features and processes disclosed herein, may be implemented in conjunction with one or more mobile modules 120.

One or more user mobile devices 110 may communicate via a network 170 with an autograph management server 150. Functionality associated with the autograph management server 150, including features and processes disclosed herein, may be implemented in conjunction with one or more server modules. These modules may include, among others, a certificate module 152, a signature module 154, an authentication module 156, an archive module 158, and/or a marketplace module 160.

The user mobile device 110 may be a digital camera, smart phone, tablet, PDA, portable computer, any other imaging capture system, or any other computing machine operable to capture an image and support the application of an electronic autograph thereupon. The application of the electronic autograph may be supported using a touchscreen, touchpad, stylus, lightpen, mouse, joystick, visual tracker, or any other input mechanism operable to receive the raster points or vectorized path of the autograph entry. The application of the electronic autograph may be supported using a wireless autograph sensor 140.

The camera sensor 130 may be a charge-coupled device (CCD), an active-pixel sensor (APS), any other image sensor, or any image sensor arranged in conjunction with other imaging components such as lenses, filters, flashes, and/or shutters. The camera sensor 130 may be used to capture an image or a series of images into the user mobile device 110.

The wireless autograph sensor 140 may be signaled using a wireless token. The token may be a radio frequency (RF) tag or an RF identifier module such as an RFID or near field communication (NFC) module. The token may be embedded within a ring, bracelet, pen, keychain, card, pendant, or other small physical item. The token may be programmed with an identifier or other information associated with the inscriber. The token may contain a representation of the inscriber's autograph or alternatively, an identifier than can be used to locate and obtain the representation of the autograph from an online resource such as the autograph management server 150. The token can support the inscriber applying their autograph by tapping, touching, or passing the token to, or near, the wireless autograph sensor 140. According to certain embodiments, the token can allow celebrities to autograph pictures without having to touch or interact with anything. This can allow the celebrity to be more engaged with their fans during performances or interaction instead of focusing on writing out autographs. Signaling the wireless autograph sensor 140 with the token can cause an acquired image to be automatically signed, saved, dated, time stamped, and/or cryptographically protected.

The autograph management server 150 can support various electronic autograph management functionality presented herein. This functionality may be implemented in conjunction with one or more server modules. These modules may include a certificate module 152 for providing cryptographic certificates to the user mobile devices 110. The autograph management server 150 can serve as a trusted third party or a public key certification authority to issue public and private keys and also certifying public keys.

The modules associated with the autograph management server 150 may also include a signature module 154. When an image is captured at the user mobile device 110 it may be digitally signed along with the applied autograph, a time/date stamp, and/or other metadata. The digital signature applied at the user mobile device 110 may use one or more cryptographic keys associated with the mobile user device 110 or an associated user. The signed image, autograph, and metadata may be transmitted to the autograph management server 150 where the signature may be verified according to the signature module 154. Optionally, a signature may be reapplied (or also applied) using one or more keys associated with the autograph management server 150.

A digital signature may be a computational and mathematical mechanism for demonstrating the authenticity of a digital message or document. A valid digital signature gives a recipient reason to believe that the contents were created and signed by a known sender (authentication). Also the sender cannot deny having sent the message (non-repudiation). The recipient may also believe that the message was not altered in transit (integrity). Digital signatures can support detection of forgery or tampering.

The modules associated with the autograph management server 150 may also include an authentication module 156. Digital signatures may be used to authenticate the origin of the acquired photo as well as verify the signature over the applied autograph, time/date stamp, and/or other metadata.

The modules associated with the autograph management server 150 may also include an archive module 158. Acquired images along with their applied signatures, timestamps, and other metadata may be transmitted from the user mobile device 110 to the autograph management server 150 for storage within an online archive on behalf of the owner or operator of the user mobile device 110. The archive may also be used to store representations of autographs on behalf of inscribers. The representations may be linked to when a token is used to signal the wireless autograph sensor 140 of the user mobile device 110 for rapid, automatic autograph application.

The modules associated with the autograph management server 150 may also include a marketplace module 160. Acquired images along with their applied signatures, timestamps, and other metadata may be collected, traded, bought, sold, auctioned, gifted, shared, or otherwise transacted. The autograph management server 150 can provide an automated, online marketplace where such transaction may take place. The use of secure cryptographic control of the materials and metadata can provide a certain level of assurance of authenticity of the images and applied autographs. For example, a protection against duplicating an applied autograph onto another acquired image or object may be supported. Similarly, a protection against applying autographs to stock or mass produced images may be supported.

It should be appreciated that while the certificate module 152, signature module 154, authentication module 156, archive module 158, and marketplace module 160 are called out as example modules associated with the autograph management server 150, the may autograph management server 150 include other modules for performing other functionality discussed herein. Furthermore, these various modules may be combined into fewer modules or may be portioned upon more than more computing machine. As such the use of autograph management server 150 in the singular is merely a non-limiting example. It should also be appreciated that functionality discussed in relationship to the autograph management server 150 and in relationship with the user mobile device 110 may be variously, and differently partitioned between modules associated with the autograph management server 150 and modules associated with the user mobile device 110 (such as the mobile module 120), according to various embodiments.

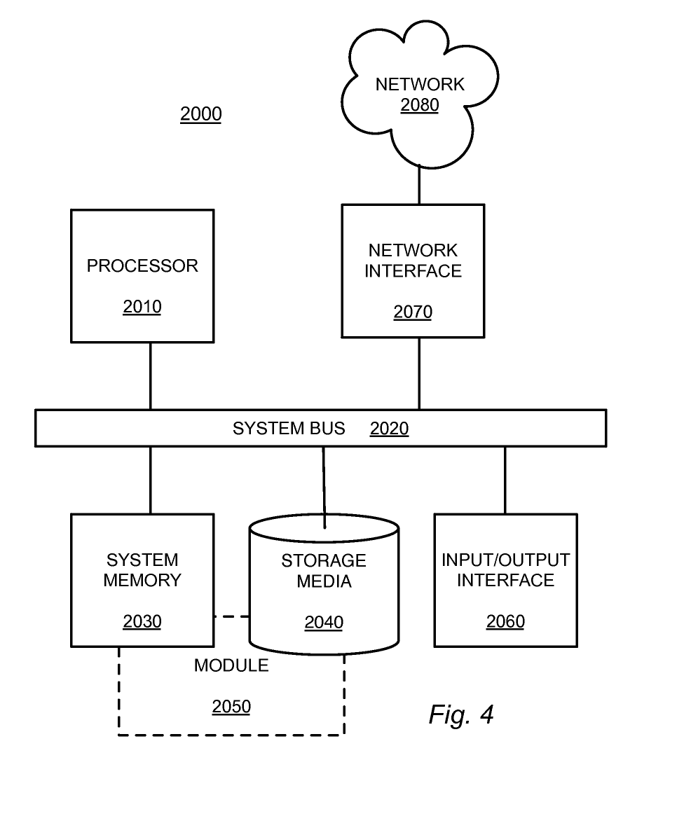

The mobile user device 110, autograph management server 150, or any other systems associated with the technology presented herein may be any type of, or collection of, computing machine such as, but not limited to, those discussed in more detail with respect to FIG. 4. Furthermore, any modules (such as the mobile module 120, certificate module 152, signature module 154, authentication module 156, archive module 158, or a marketplace module 160) associated with any of these computing machines or any other modules (scripts, web content, software, firmware, or hardware) associated with the technology presented herein may by any of the modules discussed in more detail with respect to FIG. 4. The computing machines discussed herein may communicate with one another as well as other computer machines or communication systems over one or more networks such as network 170. The network 170 may include any type of data or communications network including any of the network technology discussed with respect to FIG. 4.

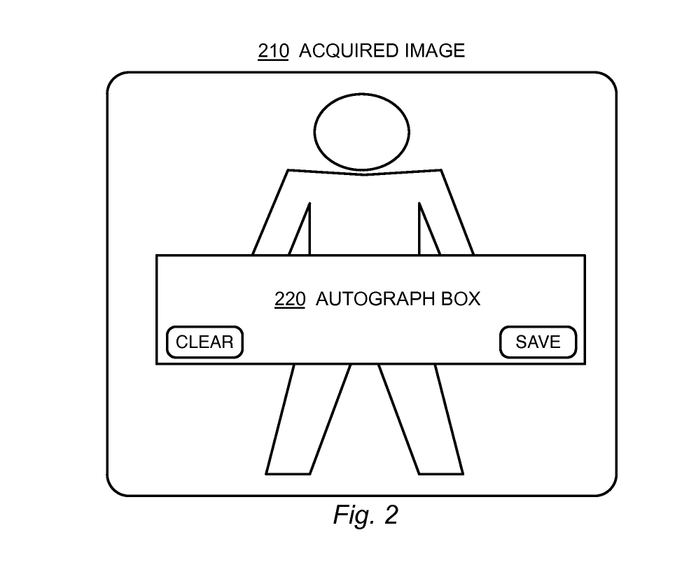

FIG. 2 is an example screen image associated with a user mobile device 110 in accordance with one or more embodiments presented herein. An acquired image 210 may be displayed on a touchscreen or other display mechanism associated with a user mobile device 110. The acquired image 210 is generally displayed immediately after, or very shortly after, an operator has taken an action to acquire the image using a camera sensor 130 associated with the user mobile device 110. Upon displaying the acquired image 210, an autograph box 220 may be presented to allow the subject of the acquired image 210 to apply their autograph. In doing so, the subject also becomes the inscriber of the acquired image 210 with their autograph.

The autograph box 220 may be presented with controls for manipulating, accepting, or restarting the autograph application. For example, a save button may be provided for the inscriber to indicate their completion of the autograph application. According to one or more embodiments the save button may change color (or become greyed out) once the save is completed in order to indicate to the inscriber that his or her autograph was applied and saved. As another example, a clear button may be provided to allow the inscriber to restart the autographing process if their applied autograph does not look right, or otherwise needs to be replied.

An autograph manipulation feature may allow the inscriber or the operator of the user mobile device 110 to manipulate the visual placement of the autograph upon the acquired image 210. Examples of such manipulation may include resizing, changing position, rotating, flipping, or changing pen color. Autograph protection mechanisms may also be used to protect against all or particular types of autograph manipulation. Such protection mechanisms may also provide protection against removing the autograph all together or from copying it onto another image or object.

It should be appreciated that multiple autograph boxes 220 may be presented to support multiple autograph applications. For example, multiple autographs may be applied when the acquired image 210 is of a team or other group of individuals. The multiple autograph boxes 220 may be presented for autographing in a sequence, as a selectable list, or physically distributed around the acquired image display.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

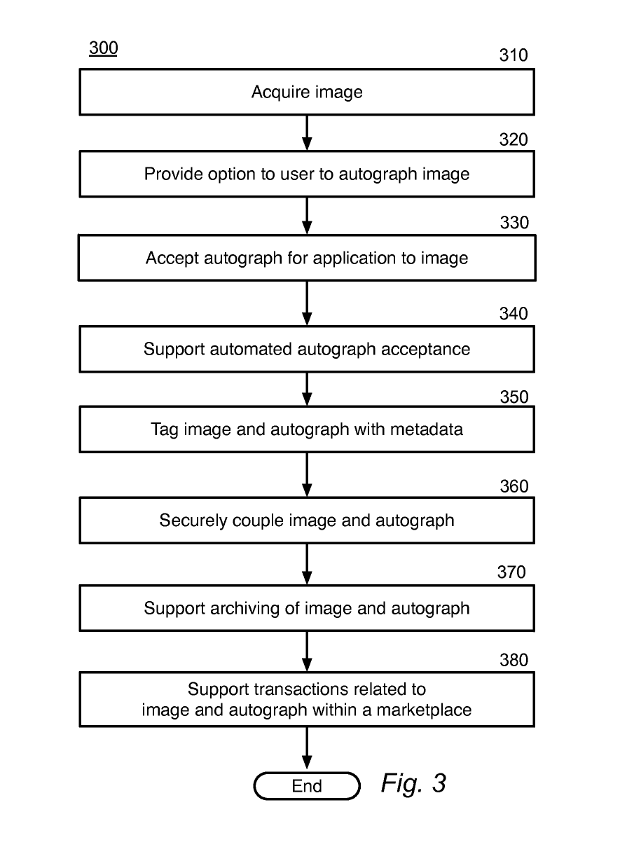

FIG. 3 is a block flow diagram depicting a method 300 for electronic autograph management in accordance with one or more embodiments presented herein. In block 310, the user mobile device 110 can acquire image. The acquired image 210 may be captured using the camera sensor 130 associated with the user mobile device 110 upon direction of a user or operator of the device.

In block 320, the user mobile device 110 can provide an option to the user or operator of the device to have the acquired image 210 autographed. A button, menu item, of other user interface element may be provided for applying one or more autographs to an acquired image 210 that was just taken or an image otherwise stored on the user mobile device 110.

In block 330, the user mobile device 110 can accept an autograph for application to the acquired image 210. For example, the user mobile device may present an autograph box 220 for the inscriber to write (or otherwise input) their autograph upon or within.

In block 340, the user mobile device 110 can support automated acceptance of an autograph from the inscriber. Such automated acceptance may occur when a token is used by the inscriber to signal the wireless autograph sensor 140 associated with the user mobile device 110.

In block 350, the user mobile device 110 can tag image and autograph with metadata. The metadata may include a time/date stamp, a geographical location, notes, links, and so forth. The metadata may also include information related to, or identifying, the user mobile device 110 used to acquire and/or autograph the acquired image 210. The metadata may also include information related to, or identifying, one or more tokens used to signal the wireless autograph sensor 140 for applying an autograph to the acquired image 210.

In block 360, the user mobile device 110 can securely couple the acquired image 210 and the applied autograph(s) together. The combined image, autographs, and metadata may be securely bound together using cryptographic hashing and/or signatures. Cryptographic keys associated with these security mechanisms may be controlled, or certified, by the autograph management server 150 or some other key infrastructure mechanism.

In block 370, the autograph management server 150 can support archiving of acquired images 210 and their associated applied autographs. Acquired images 210 along with their applied signatures, timestamps, and other metadata may be transmitted from the user mobile device 110 to the autograph management server 150 for storage within an online archive on behalf of the owner or operator of the user mobile device 110.

In block 380, the autograph management server 150 can support transactions related to acquired images 210 and their associated autographs within a marketplace. Acquired images along with their applied signatures, timestamps, and other metadata may be collected, traded, bought, sold, auctioned, gifted, shared, or otherwise transacted within or in association with a secure, online marketplace.

### Example Systems

FIG. 4 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for automated autograph management, comprising:
receiving, by a user device, a cryptographic key;
acquiring, by the user device, a digital image using an image sensor associated with the user device;
receiving, by the user device, an autograph associated with the digital image;
coupling, by the user device, the digital image and the autograph using the cryptographic key; and
storing, within the user device, the cryptographically coupled digital image and autograph.

2. The computer-implemented method of claim 1, further comprising the step of tagging the digital image with metadata such that the metadata is also coupled to the digital image using the cryptographic key.

3. The computer-implemented method of claim 1, further comprising the step of transmitting the coupled digital image and autograph to a server for storage.

4. The computer-implemented method of claim 1, further comprising the step of transmitting the coupled digital image and autograph to an online marketplace.

5. The computer-implemented method of claim 1, wherein the autograph is received from one or more human subjects photographed within the digital image.

6. The computer-implemented method of claim 1, wherein receiving the autograph comprises detecting the autograph being drawn on an input device associated with the user device.

7. The computer-implemented method of claim 1, wherein receiving the autograph comprises wireless communication between the user device and a token.

8. The computer-implemented method of claim 1, wherein using the cryptographic key comprises applying a digital signature.

9. The computer-implemented method of claim 1, wherein receiving the cryptographic key comprises receiving a cryptographic certificate.

10. The computer-implemented method of claim 1, further comprising the step of supporting the manipulation of the autograph with respect to the digital image.

11. An automated autograph management system, comprising:
one or more processing units, an image sensor, and one or more processing modules, wherein the automated autograph management system is configured by the one or more processing modules to:
receive a cryptographic key;
acquire a digital image via the image sensor;
receive an autograph associated with the digital image;
tag the digital image with metadata;
couple the digital image, the metadata, and the autograph using the cryptographic key; and
store the cryptographically coupled digital image, metadata, and autograph.
